(19) United States
(12) Patent Application Publication
(10) Pub. No.: US 2019/0084095 A1
(43) Pub. Date: Mar. 21, 2019

(54) HIGH STRENGTH, AIR HARDENING STEEL FOR USE AS WELD FILLER

(71) Applicant: SALZGITTER FLACHSTAHL GMBH, Salzgitter (DE)

(72) Inventors: JOACHIM SCHÖTTLER, Braunschweig (DE); CHRISTIAN FRITZSCHE, Salzgitter (DE)

(73) Assignee: SALZGITTER FLACHSTAHL GMBH, Salzgitter (DE)

(21) Appl. No.: 16/083,429

(22) PCT Filed: Feb. 28, 2017
(86) PCT No.: PCT/DE2017/100159

§ 371 Date: Sep. 7, 2018

(30) Foreign Application Priority Data
Mar. 9, 2016 (DE) 10 2016 104 295.1

(51) Int. Cl. B23K 35/30; C22C 38/32; C22C 38/28; C22C 38/26; C22C 38/24; C22C 38/22; C22C 38/06; C22C 38/04; C22C 38/02; C22C 38/00; B33Y 80/00

(52) U.S. Cl. CPC B23K 35/3073; C22C 38/32; C22C 38/28; C22C 38/26; C22C 38/24; B33Y 80/00; C22C 38/06; C22C 38/04; C22C 38/02; C22C 38/002; C22C 38/001; C22C 38/22

(57) ABSTRACT

A high strength, air hardening steel includes the following contents in mass-%: C: 0.07 to ≤0.16, Si: 0.12 to ≤0.80, Mn: 1.00 to ≤2.20, Cr: 0.50 to ≤1.60, Mo: 0.10 to ≤1.00, Al: 0.010 to ≤0.060, N: 0.0020 to ≤0.0150, Ti: 0.010 to ≤0.050, V+2×Nb of 0.030 to ≤0.200, B: 0.0008 to ≤0.0050, P: ≤0.020, S: ≤0.10, remainder iron, including common steel-incidental elements, for use as weld filler in wire and/or powder form.

The invention relates to a high strength, air hardening steel for use as weld filler, according to the preamble of claim 1.

In particular, the invention relates to a weld filler, which can be used for example in lightweight vehicle construction, mechanical engineering or for the cost-effective production of components using three-dimensional printing.

The hotly contested automotive market forces manufacturers i.a. to constantly look for solutions to reduce fleet consumption while maintaining highest possible comfort and greatest possible occupant protection. On one hand, weight saving of all vehicle components plays hereby a crucial role, but on the other hand also the behavior of the individual components should be as beneficial as possible with respect to high static and dynamic loads during operation as well as in the event of a crash. Suppliers attempt to address this need by reducing the wall thicknesses through the provision of high strength and super high strength steels while at the same time improving component performance during their production and operation. Such steels must therefore meet comparatively high demands in terms of strength, ductility, toughness, energy absorption and processability, for example by cold forming, welding and/or surface treatment.

But also in production engineering and in particular in industrial model making or in the production of spare parts as single-unit production or in small batches, the development of cost-effective, resource-saving and faster manufacturing processes methods is constantly being advanced.

For example, in the case of components produced by forming technology, the geometry is determinative for the required component properties. When, for example, local reinforcements on components are required due to increased mechanical stress, matching small batches normally require complicated modifications or rebuilding of forming tools that incur high costs. The production of prototype components or components in very small batches seeks, therefore, increasingly for alternative manufacturing processes.

An example involves the printing of three-dimensional components, which by now may also be produced from steel using laser printing. The laid-open publication DE 10 2014 110 662 A1 describes a method which uses a laser fusion or laser sintering process so as to be able to manufacture three-dimensionally shaped components of steel. In this case, three-dimensionally shaped components are produced layer-by-layer through build-up welding. These processes are also summarized under the term “additive manufacturing”.

In the past, conventional steels of relatively great sheet thickness, water-tempered high strength fine-grained steels, multiphase steels or alternative materials, such as aluminum, have mostly been used for the described applications in component production.

The use of conventional steels is hereby accompanied with the disadvantage of great component weight as a result of greater sheet thicknesses. Although alternative super high strength multiphase steels can be made thinner and therefore sized lighter, they have disadvantages such as poorer weldability and formability due to the high basic hardness. Water-tempered steels are expensive to manufacture and therefore are oftentimes not economically viable.

For these reasons, air hardening steel materials were developed, as an alternative, as hot or cold strip so as to overcome the disadvantages of known steels by realizing the required material properties solely by cooling of the steel in air, for example, after the component undergoes a heat treatment. Such materials are known, for example, from applicant's laid-open publications DE 10 2004 053 620 A1 and DE 10 2007 058 222 A1.

In addition to the afore-described general demands, the following mechanical characteristic values are attained in the tempered state by way of example:

Rₑ or R_{p0.2}: 700-850 [MPa]

### Rₘ: 800-1000 [MPa]

### A₈₀: ≥11 [%]or

### A₅: ≥13 [%]

When the steel strip, after undergoing hot rolling at least in part in air, cools down fast enough so that the air hardening effect begins, cold formability of the steel strip can be realized by a subsequent soft annealing process, e.g. in hood-type annealing, or by homogenizing annealing. The cold formability may alternatively also be maintained after hot rolling, when a correspondingly tightly wound coil slowly cools down, possibly in a special heat-insulated hood.

After cold forming or shaping of the steel strip or a blank made from this steel strip, the air tempering state can then be adjusted again by a subsequent heat treatment.

When such steels have to undergo joint welding or build-up welding or components have to be manufactured by using of 3D printing, it has hitherto been customary to select the weld filler in accordance with the required mechanical properties of the component such as, e.g., strength and toughness.

Air hardening weld fillers are known for joint welding from laid-open publication DE 24 35 577 A1 and for build-up welding from patent publication DE 33 05 633 C2.

These known weld fillers are not economically viable because of their alloying concept with high contents of expensive alloying elements, such as, for example, nickel and molybdenum.

The invention is therefore based on the object to use another alloying concept in order to provide a high strength, air hardening steel for use as weld filler for the production of joint and build-up welds, which alloying concept is cost-effective, while at the same time ensuring superior overall weldability. In addition, the weld filler should be particularly suitable for three-dimensional printing of components made of this steel using laser fusion welding or laser sintering.

According to the teaching of the invention, this object is achieved by a high strength, air hardening steel with the following contents in mass-%:

### C 0.07 to ≤0.16

### Si 0.12 to ≤0.80

### Mn 1.00 to ≤2.20

### Cr 0.50 to ≤1.60

### Mo 0.10 to ≤1.00

### Al 0.010 to ≤0.060

### N 0.0020 to ≤0.0150

### Ti 0.010 to ≤0.050

### B 0.0008 to ≤0.0050

### P≤0.020

### S≤0.010

### V+2×Nb 0.030 to ≤0.200

remainder iron, including common steel-incidental elements, for use as weld filler in wire and/or powder form.

The high strength, air hardening weld filler according to the invention is characterized by the realization of a cost-effective alloying concept as a result of the omission of nickel and reduced molybdenum content, and realization of a reduced content of C and Mn in comparison to the known air hardening weld fillers so as to achieve superior general weldability with superior forming properties at the same time.

The weld filler according to the invention is moreover well suitable for all fusion welding processes, in particular inert gas metal arc welding, for the production of components using three-dimensional printing, for example using the laser fusion or laser sintering process.

3D printing of components or application of reinforcements to three-dimensionally shaped components by build-up welding using the air hardening weld filler according to the invention also eliminates advantageously fluctuations in the material properties in the heat impact zone due to the air hardening effect as a result of the very good hardenability and relatively slow cooling.

Tests have shown that the Cr content decisive for the air hardening effect can be lowered to a value which is noncritical for avoiding chromium carbide precipitations during welding, when at the same time the air hardenability of the steel is improved again using a complex alloying concept based on Cr—Mo—Ti—B.

According to the invention, the alloying concept is based on the recognition that in contrast to the known steel for seamless tubes, in which nitrogen has to be completely bound by titanium in order to avoid boron nitride precipitations and thus to ensure the effectiveness of the added boron, the nitrogen is also bound by other alloying elements such as Cr or Mo.

The determination of an overstoichiometric titanium addition in relation to nitrogen is therefore no longer necessarily required. By adding vanadium, precipitates of vanadium carbon nitrides of type V(C,N) are released at higher tempering temperatures and counteract a decrease in strength by a secondary hardening.

Similar to vanadium, niobium also forms precipitates in the form of carbides or carbon nitrides. In addition to a grain refinement, these precipitations can also contribute to improving tempering resistance.

When both elements are added to the alloy, a range of 0.030 to ≤0.200 has proven beneficial for the sum of V+2×Nb in mass-%.

On the basis of this knowledge, the afore-described alloying concept according to the invention has been determined, wherein the following analysis range for the weld filler has been found to be particularly advantageous for a combination of cost-effective alloying concept, good weldability and good air hardenability:

### C 0.07 to ≤0.12

### Al≤0.05

### Si 0.20 to ≤0.40

### Mn 1.60 to ≤2.10

### P≤0.020

### S≤0.010

N 0.0030 to ≤0.0125, advantageously 0.0030 to ≤0.0080

### Cr 0.70 to ≤0.85

### Mo 0.20 to ≤0.35

### Ti 0.02 to ≤0.04

### V+2×Nb 0.05 to ≤0.12

### B 0.0020 to ≤0.0040

remainder iron including common steel-incidental elements.

As further tests on the weld filler according to the invention have shown, this steel is not only advantageously usable in the automotive sector for joining high strength steels, but also for 3D printing of components made of this steel material. The steel according to the invention is hereby used as a powder, for example for laser sintering or as wire for build-up welding using laser.

The advantages of this air hardening weld filler according to the invention are listed again hereinafter:
very good general weldability for joint and build-up welding
use for welded, statically and dynamically highly stressed components,
more cost-effective than comparable alloying concepts
excellent suitability for 3D printing of components using arc or fusion welding

What is claimed is:

1.-13. (canceled)

14. A high strength, air hardening steel, comprising the following contents in mass-%:
C 0.07 to ≤0.16
Si 0.12 to ≤0.80
Mn 1.00 to ≤2.20
Cr 0.50 to ≤1.60
Mo 0.10 to ≤1.00
Al 0.010 to ≤0.060
N 0.0020 to ≤0.0150
Ti 0.010 to ≤0.050
V+2×Nb 0.030 to ≤0.200
B 0.0008 to ≤0.0050
P≤0.020
S≤0.010
remainder iron, including common steel-incidental elements, for use as weld filler in wire and/or powder form.

15. The steel of claim 14, wherein the C content is 0.07 to ≤0.12%.

16. The steel of claim 14, wherein the Si content is 0.20 to ≤0.40%.

17. The steel of claim 14, wherein the Mn content is 1.60 to ≤2.10%.

18. The steel of claim 14, wherein the N content is 0.0030 to ≤0.0125%.

19. The steel of claim 14, wherein the N content of 0.0030 to ≤0.0080%.

20. The steel of claim 14, wherein the Cr content is 0.70 to ≤0.85%.

21. The steel of claim 14, wherein the Mo content is 0.20 to ≤0.35%.

22. The steel of claim 14, wherein the Ti content is 0.02 to ≤0.04%.

23. The steel of claim 14, wherein the steel has a total content of vanadium and niobium in the form of V+2×Nb of 0.05 to ≤0.12%.

24. The steel of claim 14, wherein the B content is 0.0020 to ≤0.0040%.

25. The steel of claim 14, for use as weld filler for joint welding, build-up welding or three-dimensional printing of components made from said steel.

26. The steel of claim 14, for use as weld filler for arc welding, in particular inert gas metal arc welding and for laser fusion welding and laser sintering.
